(19) United States
(12) Patent Application Publication
(10) Pub. No.: US 2008/0034277 A1
(43) Pub. Date: Feb. 7, 2008

(54) System and method of the same

(76) Inventor: Chen-Jung Hong, Hsin-Chu City (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/491,181

(22) Filed: Jul. 24, 2006

(51) Int. Cl. G06F 17/00; G06F 3/00

(52) U.S. Cl. 715/202; 715/201; 715/730; 715/203

(57) ABSTRACT

An interactive multimedia integration system includes an input unit, a file format recognition unit, an editing unit, a format generating unit. The editing unit is for integrating selected interaction data into a combined multimedia file. The format generating unit produces an integrated interactive multimedia file upon a request from the user. The integrated interactive multimedia file contains at least three formats which are a raw interactive multimedia file, a dedicated interactive multimedia file and an ordinary file attached an interactive script which contains the interaction data selected by the user. The integrated interactive multimedia file is playable in an ordinary playing device without interactive functions, or a dedicated playing device with specific interactive functions.

### BACKGROUND OF THE INVENTION

1. Field of the Invention

The present invention relates to an interactive multimedia integration system and the method of integrating multimedia files with different formats into one integrated file, and more particularly relates to an integration medium system with a dedicated file format that is playable in different mobile devices with several interactive functions.

2. The Related Art

Since the present hardware and software in computing technologies are developing more and more advanced continuously, the capability of handling mass dada analysis and media contents are increased dramatically as well. Further by the support of the decoding software, most of the multimedia files with different formats are therefore capable to be played via a personal computer. The user simply clicks on the file shown in the file browsers and the display of the personal computer is able to play footages as chosen. There is no need of utilizing an auxiliary multimedia complier or transforming software to transfer the multimedia file from one file format to another file format. However, since the hardware and the firmware of portable devices, such as the digital still camera, digital camcorder, mobile phone, personal digital assistant, personal media player and the gaming device, are dramatically improved, the functions and capabilities of the portable devices are enhanced as well. The additional functions, beside the primary working functions, are usually the gaming, photo taking, movie recording, diary detailing and others, which are available to the market. Now the camera for taking still photos and video clips, and the large display for playing the recorded clips are the most popular auxiliary function to most of the portable devices. In order to acquire the good quality of clips, different manufacturers employ different compression format, such as MOV, MPEG-4, AVI and so on. Besides, the multimedia files are usually consuming large memory for images and sounds. This result also makes the memory card getting larger and larger capacity such as 512 MB, 1 GB, 2 GB or even 4 GB.

Some other manufacturers may develop the dedicated multimedia file format to achieve individual requirements. The dedicated file format may benefit on sound quality and small size of file, but giving away the video quality. The other dedicated file format may benefit on video clips, but giving away both the file size and the sound quality. However, no matter what dedicated file format is chosen or developed, the basic problem is that such file is unplayable on the other device that does not support such dedicated file format. Sometimes, if the personal computer does not install the dedicated driver for such portable device, the dedicated multimedia file is unable to be transferred to the storage of the computer.

Even though the portable devices are limited somehow by the hardware and firmware, such as unable to modify or share files to other portable devices, the format transforming or modifying function can be done by the assistant of the computer if installed the needed driver and the software. However, the interactive actions are not introduced to the multimedia file. The portable device is only capable to simply play, pause, or stop the transformed or the modified multimedia file.

Besides, some manufacturers have chosen a commonly utilized file, format into their devices for popularly sharing purpose, such as choosing MOV, AVI or MPEG-4. But the drawbacks are that these kinds of formats are still not supporting the interactive action or function to the multimedia file itself. The commonly utilized file format is simply read to play the multimedia contents to the viewer on an embedded display by the portable device. Even if the manufacturer develops a dedicated file format capable of showing interactive functions, it is unable to be shared by the other devices since the file format is unique and dedicated to its brand. Therefore, there is a need to develop a universal file format or a multimedia file which is capable to generate interactive functions as well as sharing interactive multimedia files to each others in different brands or different manufacturers.

### SUMMARY OF THE INVENTION

It is therefore an object of the present invention to provide an integrated interactive multimedia file which contains selected interaction information. If the integrated interactive multimedia file is played in a dedicated playing device, the interactive functions will be displayed and demonstrated. If the integrated interactive multimedia file is sent to an ordinary playing device, the multimedia file will be displayed. However, the interactive functions will not be demonstrated. Either way, the integrated interactive multimedia file is easily shared between different playing devices.

To achieve the former object, an interactive multimedia integration system, comprising an input unit for connecting a multimedia generating device, a file format recognition unit, connecting said input unit, for recognizing a multimedia file transmitted from said multimedia generating device, an editing unit for integrating interaction data into said multimedia file, and a format generating unit for producing an integrated interactive multimedia file, further comprising a dedicated format integration unit for transforming said integrated interactive multimedia file into a dedicated interactive multimedia file which is playable on a dedicated player, and an interaction data appending unit for appending a interactive script, which is transformed from said interaction data, to the end of said multimedia file.

In order to achieve the object and function as described in the above, the multimedia generating device is a digital video camcorder.

In order to achieve the object and function as described in the above, the multimedia generating device is a digital still camera which is capable of taking motion pictures.

In order to achieve the object and function as described in the above, the interaction script includes frame segments and corresponding remarks.

It is yet another object of the present invention to provide a method for integrating a multimedia file, comprising the steps of: (a) inputting a first multimedia file from a generating device; (b) editing said first multimedia file into another format; (c) remarking interaction data into said first multimedia file; (d) transforming said first multimedia file with remarked said interaction data, into an integrated interactive multimedia file; (f) outputting said integrated interactive multimedia file into a playing device; (g) producing and outputting a dedicated interactive multimedia file from said integrated interactive multimedia file upon a first request; and (h) attaching to the end of said first multimedia file with an interactive script and thereto output said first multimedia file and said interactive script as a whole.

In order to achieve the forgoing object and function as described in the above, after step (a) as shown in the above, further step of combining a second multimedia file into said first multimedia file is introduced.

In order to achieve the forgoing object and function as described in the above, the interaction data is a recursive point for a film jumping purpose.

The above-mentioned and other features and objects of this invention and the manner of attaining them will become more apparent and the invention itself will be better understood by reference to the following description of a preferred embodiment of the invention taken in conjunction with the accompanying figures wherein:

### BRIEF DESCRIPTION OF THE DRAWINGS

FIG. 1 is a perspective view showing the connection of the present invention and other portable devices;

FIG. 2 is a flow chart showing the multimedia file be recognized and be processed by the interactive multimedia integration system;

FIG. 3 is a detailed block diagram showing the multimedia file be processed to different interactive multimedia file and then be output;

FIG. 4A shows a first interactive file format by inserting marks in-between several segments;

FIG. 4B shows the integrated interactive file format by appending scripts;

FIG. 4C shows the assigned commonly utilized file format by attaching interactive scripts;

FIG. 5A is a table showing the content of the mark;

FIG. 5B is a table showing the content of the script; and

FIG. 6 shows the method of integrating the input multimedia files with selected interactive effects.

### DETAILED DESCRIPTION OF THE PREFERRED EMBODIMENT

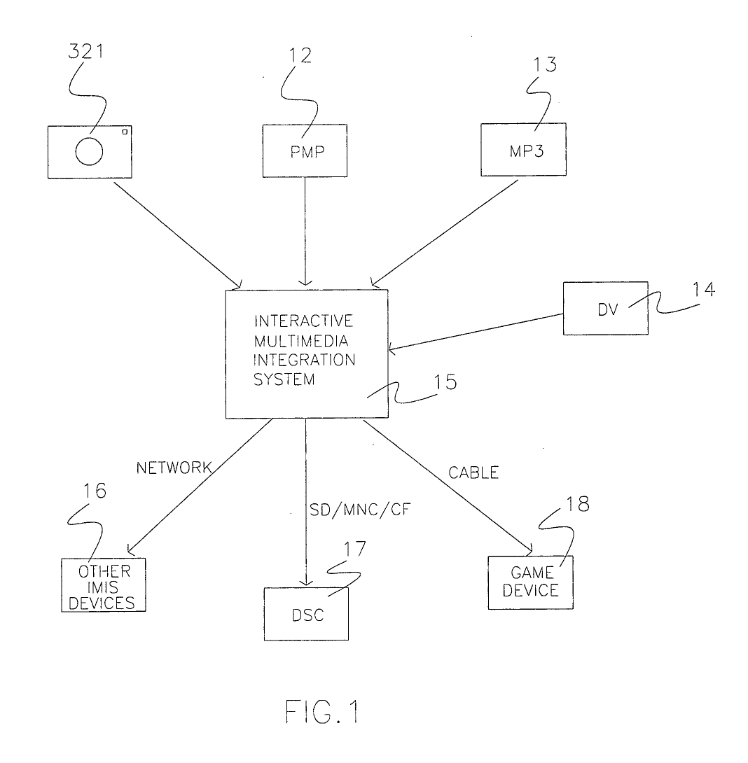

Referring to FIG. 1, files in different formats generated in the digital still camera (DSC) 11, personal media player (PMP) 12, MP3 player 13 and digital video camcorder (DV) 14 are transferred to an interactive multimedia integration system (hereinafter as “IMIS”) 15 via several connection methods, such as though cable, USB port, memory cards (CF, SD, MMC or the like) and wireless connection (Blue Tooth, 102.11 a/b/g or the like), Further after appending interactive codes or scripts to the file, the IMIS 15 will output the integrated interactive file to a designated devices, such as another DSC 17, a portable gaming machine 18 or another IMIS for playing purpose. The output connection includes the ways of cable connection, USB port, memory cards and the wireless connection as well. Besides, the IMIS 15 may contain a device recognition interface for assigning a firmware/driver once a recognized device is connected to the IMIS 15. The recognition interface may also recognize an output device if a playing device is connected to the IMIS 15. In this case, the IMIS 15 will transform the output interactive multimedia file into an accepted format in accordance with the recognized playing device. For instances, if the playing device is another IMIS 15, the system will generate and output an IMIS file. If the playing device is an ordinary portable media player, the system will output a commonly utilized file format but appending an interactive scripts. In this case, even if the playing device does not support interactive function, the multimedia file is still able to be played, only the interactive functions being filtered. Further if the playing device is a particular designed playing device, the system will output files consisting of different formats and interactive marks between formats. In view of the above, it is shown that the IMIS 15 device may be implemented a display for playing multimedia file purpose.

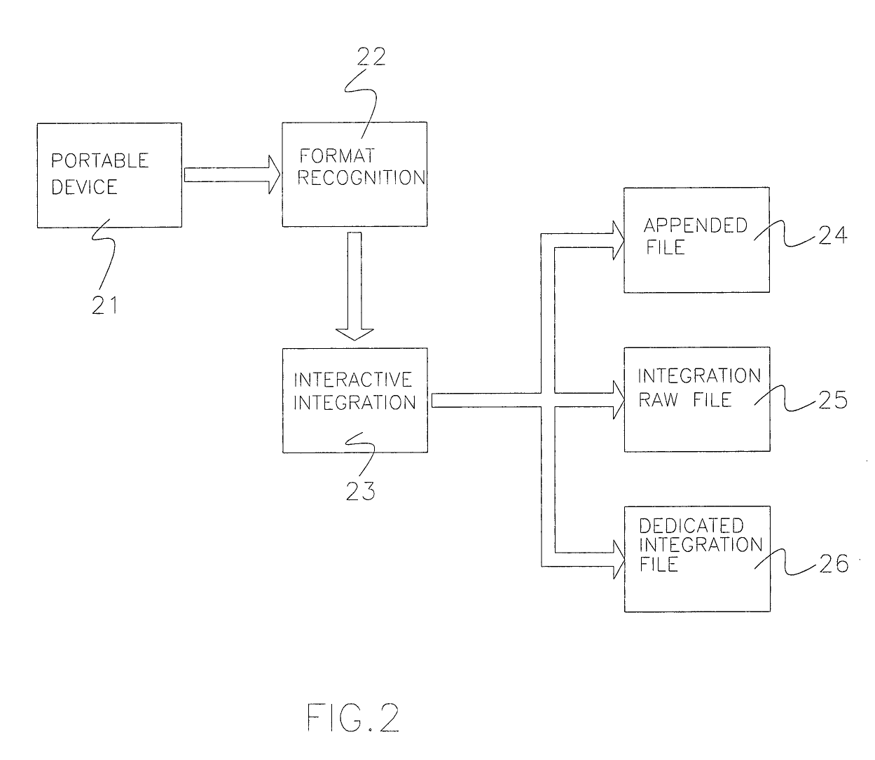

Referring to FIG. 2, it shows the function block diagram of the present invention. At first, the portable device 21, such as DSC or DV, is connected to a format recognition block 22. The format recognition block 22 will recognize the file format and further initiate a proper driver to download the multimedia file which is generated or stored in the portable device 21. There is a mapping table for the format recognition block 22 to sort out the brand and the model name of the connected portable device 21. The multimedia file will be sent to the integration block 23 of IMIS for further interactive data processing. The interactive data process is by appending interaction scripts or inserting interaction marks between different formats. By the request of the user, the integration block 23 of IMIS will generate three kinds of format, such an ordinary multimedia file appending an interaction script shown as the block 24, an IMIS format raw interaction file shown as the block 25 or an dedicated interaction file shown as the block 26. After the integrating and generating process, a playing device can display the multimedia file with interactive instruction information once the interactive multimedia file is transmitted by an output device 36.

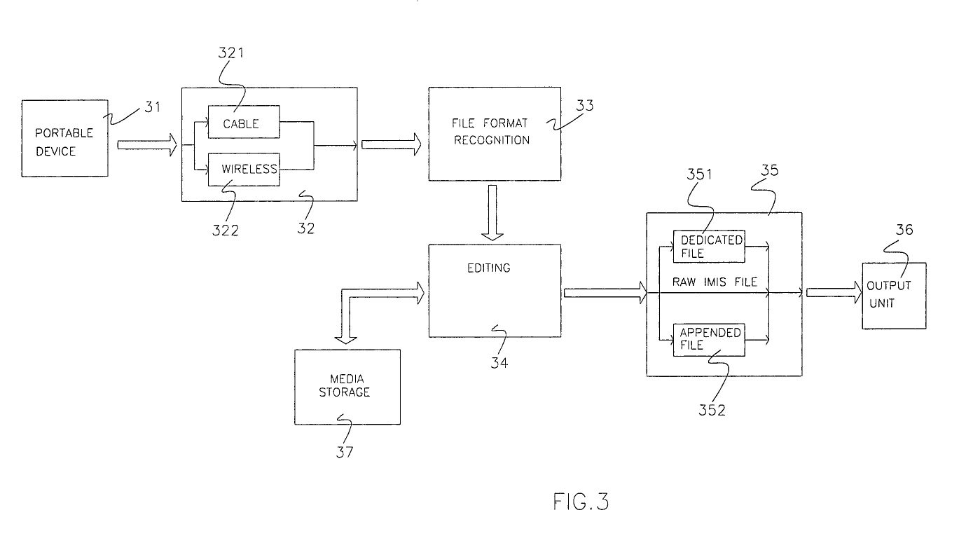

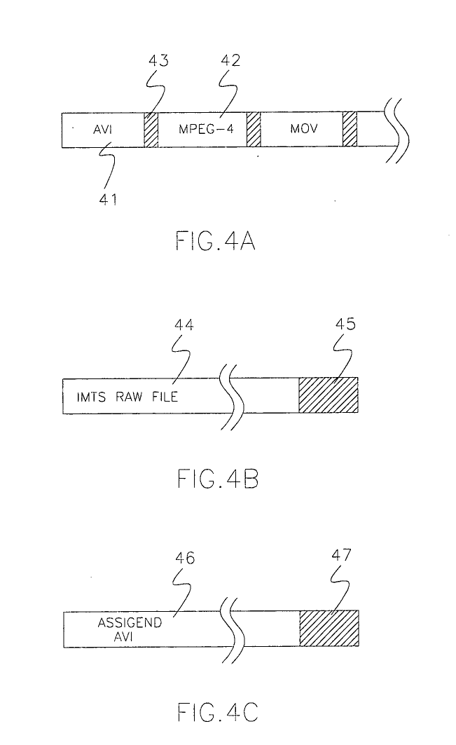

Please refer to FIG. 3, the block diagram shows the detailed processing and integrating method of the present invention. The interactive multimedia integration system includes an input unit 32, a file format recognition unit 33, an editing unit 34, a format generating unit 35 and an output unit 36. The input unit 32 connects a portable device for inputting the multimedia file produced or stored in the portable device into the system. The connection of the input unit 32 and the portable device may either by a cable connection 321 or by a wireless connection 322. The file format recognition unit 33 is utilized for recognizing the file format of the portable device and further setting a proper connection to transmit the multimedia file into the editing unit 34. The editing unit 34 employs a storage unit 37 (such as a hard disk or a ram) for inserting interaction marks or appending interaction scripts. The interaction codes contained in the inserted marks or the appended scripts are fade-in, fade-out, menu, jump-to, remark and so on. Such codes are the basic for interactive functions. However, wide variation of interaction codes may be introduced at a higher complex system. Regarding the functions of the file generating unit 35 includes the direct raw IMIS file output, the dedicated file generating 351 and the ordinary file out with appending interaction code 352. Firstly the raw IMIS file output is outputting the file directly from the editing unit 34 to the output unit, without making any processing onto the integrated IMIS file which is a raw interactive multimedia file. If the user would like to employ an ordinary multimedia player for displaying purpose but wish to keep the interaction codes make to the file previously, the file generating unit 35 may generate the ordinary multimedia file (such as MOV, AVI or MPEG-4) by appending an interactive script segment such as shown in the block 352 and shown in FIG. 4C. If the user would like to employ a dedicated player for playing the integrated interactive multimedia file, the block 351 of dedicated file generating is employed. The multimedia file with interaction information will be produced to the dedicated file and further sent to the out unit 36 for transmitting to a dedicated player which is capable of playing an integrated interactive multimedia file.

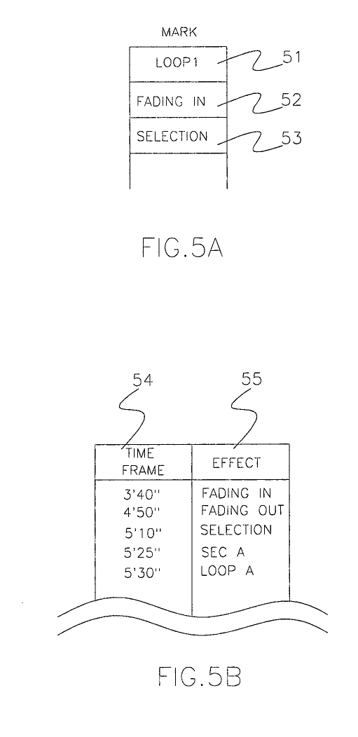

Further referring to FIG. 4A, the raw IMIS file format is shown. The multimedia files with different formats, such as the AVI file 41 and MPEG-4 file 42, are integrated altogether. Specifically, between the AVU file 41 and the MPEG-4 file 42, there is inserted an interactive mark 43 for containing interaction information or the interaction codes. If the player is capable of playing different format and recognizing the interactive codes, the raw IMIS file could be played interactively. The interactive mark, as shown in FIG. 5A, contains interaction information such as the loop name 51, fade-in 52, section remark 53, menu or others. In accordance with the interaction information, different arrangements of the marks and the files would produce different interactive effects, such as jumping to a specific loop, or recursive jumps, a menu, or fade-in effects.

FIG. 4B shows another IMIS file which is transformed from the raw IMIS multimedia file to a dedicated interactive multimedia file. The interaction script 45, which contains interaction codes, is located at the back of the file, more likely as a tailor of the dedicated IMIS file. The file format is specifically and substantially changed to another way which is different to AVI, MOV, MPEG-4 and others. The purpose of the dedicated multimedia file is for eliminating duplex information and data contained in input file segments as shown in FIG. 4A. This would shorten the length of the multimedia file and further reduce the size of an integrated interactive multimedia file. Particularly, the dedicated format of the interactive multimedia file 44 may be well integrated on the interaction references from the script 45 to the interactive multimedia file 44. In this case, the scrip 45 may contain only simple file information and code names, such as the source of the file, the length of the film, author name, compatible specification, fade-in function, menu function, fade-out function, jumping and so on. If the interactive multimedia file 44 is not dedicated (or not specifically designed for), the script 45 will be more complex for containing much more interaction information and remarks. Such example will be shown in FIG. 5B.

In case of the interactive multimedia to be displayed in an ordinary playing device, such as the DVD player, mobile phone or the DSC, the raw IMIS file and the dedicated IMIS file may be transformed to a commonly utilized file format such by appending interaction information at the end of the ordinary multimedia file as the AVI, MOV, MPEG-4 and so on. Please refer to FIG. 4C. The ordinary file 46 (or so-called the commonly utilized multimedia file) is attached the section of interactive script 47 which contains the interaction information and controlling data. The contents of the interactive script 47 are shown in FIG. 5B. The interactive script 47 contains the interaction codes, basically divided by two major categories of the time frame 54 and the effect remark 55. The Time frame 54 shows the segment or the specific point of the time frame, such as the 3′40″, 4′5″, 5′33″ and so on. The effect remark 55 represents the interactive effects during the segment or the start of a specific point recorded in time frame column 54. The interactive effects may be remarked as fade-in, fade-out, menu, jumping, recursive, loop name or others. The interaction script and the contained interaction data may not be able to be interpreted by all kinds of the playing devices. However, if the playing device doesn't support the interactive function, the integrated interactive multimedia file as shown in FIG. 4c is still be able to be played without any interactive functions. In this case, the appended interactive scripts would not bar the sharing capacity of the present invention.

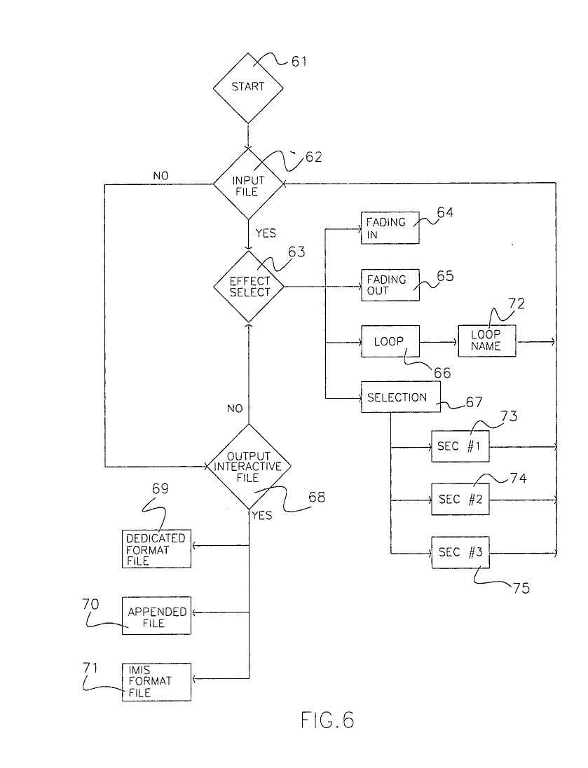

The system function block diagram of the present invention, particular to the integration, is shown in FIG. 6. When method of integration starts in block 61, the system will recognize the connected device and then download files from it as shown in block 62. If there is a multimedia file inputted to the system, the effect selection function 63 will be initiated for recording the interaction data, such as the fade-in 64, fade-out 65, loop 66, selection of clips 67 or the others, in conjunction with the inputted multimedia file. The selection function 67 further contains the record of selected film sections, such as the first section 73, the second section 74, or the third section 75. Moreover, if the loop function 66 is determined, the loop name 72 will be further recorded in the interactive marks or scripts. The interactive effect selection may include much more interactive codes rather than just shown in the embodiment of the present invention. After all the effect selection is done, the system will go back to block 62 for checking an auxiliary file in the connected device, which has not been downloaded yet. If there do exist the auxiliary file, the method as described as above will repeat. However, if there are no more files, the system will go further to block 68.

The function of block 68 is for outputting purpose. Once the integration is done and all interaction data are integrated into the interactive marks or the script. The system may produce and output the integrated interactive multimedia file into at least three kinds of file formats, depending upon the connected playing device. The first file format, as shown as the block 69, is the dedicated file format which is transformed from the raw IMIS format as block 71. Definitely, if the connected playing device is an IMIS player itself, the raw IMIS file format could be generated and outputted for future modification flexibilities. However, if the connected playing device is assumed an ordinary playing device which doesn't support the integrated interactive multimedia file, the output function 68 of the system will therefore output the supported ordinary multimedia file by appending all interaction data as one interactive script at the end of such file. By the flexibilities of integrated interactive multimedia files of the present invention, the interactive multimedia file could be shared at very wide variety of playing devices.

Accordingly, there has been disclosed the present invention. While an illustrated embodiment of this invention has been disclosed herein, it is understood that various modifications and adaptations to the disclosed embodiment are possible, and it is intended that this invention be limited only by the scope of the appended claims.

What is claimed is:

1. An interactive multimedia integration system, comprising:
an input unit for connecting a multimedia generating device;
a file format recognition unit, connecting said input unit, for recognizing a multimedia file transmitted from said multimedia generating device;
an editing unit for integrating interaction data into said multimedia file; and
a format generating unit for producing an integrated interactive multimedia file, further comprising,
a dedicated format integration unit for transforming said integrated interactive multimedia file into a dedicated interactive multimedia file which is playable on a dedicated player, and
an interaction data appending unit for appending an interactive script, which is transformed from said interaction data, to the end of said multimedia file.

2. The interactive multimedia integration system of claim 1, where said multimedia generating device is a digital video camcorder.

3. The interactive multimedia integration system of claim 1, where said multimedia generating device is a digital still camera which is capable of taking motion pictures.

4. The interactive multimedia integration system of claim 1, where said interaction data is a fade-in code.

5. The interactive multimedia integration system of claim 1, where said interaction data is a menu code.

6. The interactive multimedia integration system of claim 1, where said interaction data is a recursive point for a looping purpose.

7. The interactive multimedia integration system of claim 1, where said interaction data is a recursive point for a looping purpose

8. The interactive multimedia integration system of claim 1, where said interaction script includes frame segments and corresponding remarks.

9. The interactive multimedia integration system of claim 1, further comprising a storage device for storing said multimedia file and said interaction data.

10. A method for integrating a multimedia file, comprising the steps of:
a. inputting a first multimedia file from a generating device;
b. editing said first multimedia file into another format;
c. remarking interaction data into said first multimedia file;
d. transforming said first multimedia file with remarked said interaction data, into an integrated interactive multimedia file;
f. outputting said integrated interactive multimedia file into a playing device;
g. producing and outputting a dedicated interactive multimedia file from said integrated interactive multimedia file upon a first request; and
h. attaching to the end of said first multimedia file with an interactive script and thereto output said first multimedia file and said interactive script as a whole.

11. The method for integrating a multimedia file of claim 10, after the step of a, further comprising a step of combining a second multimedia file into said first multimedia file.

12. The method for integrating a multimedia file of claim 10, wherein said generating device is a digital still camera which is capable of taking motion pictures.

13. The method for integrating a multimedia file of claim 10, wherein said interaction data is a fade-in code.

14. The method for integrating a multimedia file of claim 10, wherein said interaction data is a menu code for a selection purpose.

15. The method for integrating a multimedia file of claim 10, wherein said interaction data is a recursive point for a film jumping purpose.

16. The method for integrating a multimedia file of claim 10, wherein said interactive script comprises a list of frame segments and corresponding remarks.
